(19) United States
(12) Patent Application Publication
(10) Pub. No.: US 2024/0027201 A1
(43) Pub. Date: Jan. 25, 2024

(54) INFORMATION PROCESSING SYSTEM, INFORMATION PROCESSING METHOD, AND STORAGE MEDIUM

(71) Applicant: NEC Corporation, Tokyo (JP)

(72) Inventor: Kenji Kondo, Tokyo (JP)

(73) Assignee: NEC Corporation, Tokyo (JP)

(21) Appl. No.: 18/222,408

(22) Filed: Jul. 14, 2023

(30) Foreign Application Priority Data
Jul. 22, 2022 (JP) 2022-117513

(51) Int. Cl. G01C 21/34; G01C 21/36

(52) U.S. Cl. CPC G01C 21/3415; G01C 21/3492; G01C 21/3691; G01C 21/3423; G01C 21/3617; G01C 21/362

(57) ABSTRACT

To reduce congestion while improving satisfaction of a user who moves to escape the congestion, an information processing system includes: a prediction section that refers to people distribution information in a plurality of areas, to predict a future congested area and a future uncongested area among the plurality of areas; an extraction section that refers to user information on one or more users staying in the congested area and information related to the uncongested area, to extract a target user from the one or more users staying in the congested area, the target user being a target to be recommended to move to the uncongested area; and an output section that outputs movement information for prompting the target user to move to the uncongested area.

### CROSS REFERENCE TO RELATED APPLICATIONS

This application is based upon and claims the benefit of priority from Japanese Patent Application No. 2022-117513 filed on Jul. 22, 2022, the disclosure of which is incorporated herein in its entirety by reference.

### TECHNICAL FIELD

The present invention relates to techniques for reducing congestion.

### BACKGROUND ART

Patent Literature 1 describes a technique for inferring the number of persons unable to use a station included in a railway line as the required number of persons to be retained. Further, in this technique, a plurality of retaining areas (such as stores) accessible to people in the station are selected so that the total capacity of each area is greater than or equal to the required number of persons to be retained, and then, guidance information for guiding people to each of the retaining areas is distributed.

### CITATION LIST

### Patent Literature

### Patent Literature 1

Japanese Patent Application Publication Tokukai No. 2015-108913

### SUMMARY OF INVENTION

### Technical Problem

In the technique disclosed in Patent Literature 1, the guidance information is delivered to displays or speakers situated in the station, stores, and trains. Alternatively, in the technique, the guidance information is delivered to portable terminals of users who are inferred to pass through the station. As such, in the technique, the information for delivery is delivered to all the users, without choice, who are present in or around the station where congestion is predicted. Therefore, there is a case in which the satisfaction of a user who moves to escape the congestion is not high.

An example aspect of the present invention is attained in view of this problem, and an example object thereof is to provide a technique for reducing congestion while improving satisfaction of a user who moves to escape the congestion.

### Solution to Problem

An information processing system according to an example aspect of the present invention includes at least one processor, the at least one processor carrying out: a prediction process of referring to people distribution information in a plurality of areas, to predict a future congested area and a future uncongested area among the plurality of areas; an extraction process of referring to user information on one or more users staying in the congested area and information related to the uncongested area, to extract a target user from the one or more users staying in the congested area, the target user being a target to be recommended to move to the uncongested area; and an output process of outputting movement information for prompting the target user to move to the uncongested area.

An information processing method according to an example aspect of the present invention is an information processing method carried out by at least one processor, the method including: referring to people distribution information in a plurality of areas, to predict a future congested area and a future uncongested area among the plurality of areas; referring to user information on one or more users staying in the congested area and information related to the uncongested area, to extract a target user from the one or more users staying in the congested area, the target user being a target to be recommended to move to the uncongested area; and outputting movement information for prompting the target user to move to the uncongested area.

A non-transitory storage medium according to an example aspect of the present invention is a non-transitory storage medium storing a program for causing a computer to carry out: a prediction process of referring to people distribution information in a plurality of areas, to predict a future congested area and a future uncongested area among the plurality of areas; an extraction process of referring to user information on one or more users staying in the congested area and information related to the uncongested area, to extract a target user from the one or more users staying in the congested area, the target user being a target to be recommended to move to the uncongested area; and an output process of outputting movement information for prompting the target user to move to the uncongested area.

### Advantageous Effects of Invention

According to an example aspect of the present invention, it is possible to reduce congestion while improving satisfaction of a user who moves to escape the congestion.

### BRIEF DESCRIPTION OF DRAWINGS

FIG. 1 is a block diagram illustrating the configuration of an information processing system in accordance with a first example embodiment.

FIG. 2 is a flowchart illustrating the flow of an information processing method in accordance with the first example embodiment.

FIG. 3 is a schematic diagram for describing an outline of an information processing system in accordance with a second example embodiment.

FIG. 4 is a schematic diagram for describing the configuration of the information processing system in accordance with the second example embodiment.

FIG. 5 is a diagram for describing an example of distribution information.

FIG. 6 is a diagram for describing an example of user information.

FIG. 7 is a diagram for describing an example of event information.

FIG. 8 is a diagram for describing an example of congestion determination information.

FIG. 9 is a diagram for describing an example of ideal number-of-person information.

FIG. 10 is a flowchart illustrating the flow of an information processing method in accordance with the second example embodiment.

FIG. 11 is a diagram illustrating an example of information predicted on an attribute basis.

FIG. 12 is a diagram illustrating an example of information predicted for each area.

FIG. 13 is a diagram for describing a specific example of a delivery list.

FIG. 14 is a diagram for describing a specific example of a transportation plan.

FIG. 15 is a diagram for describing a specific example of a delivery message displayed on a display section of a user terminal.

FIG. 16 is a diagram for describing a specific example of a delivery message displayed on a display section of an administrative terminal.

FIG. 17 is a diagram illustrating an example hardware configuration of an information processing system in accordance with each example embodiment.

### EXAMPLE EMBODIMENTS

### First Example Embodiment

The following description will discuss a first example embodiment of the present invention in detail with reference to the drawings. The present example embodiment is a basic form of an example embodiment described later.

### Configuration of Information Processing System 1

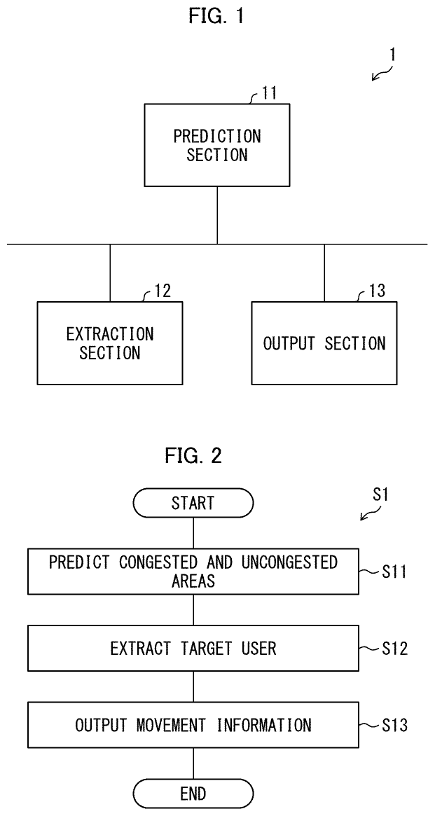

The following description will discuss the configuration of an information processing system 1 in accordance with the present example embodiment with reference to FIG. 1. FIG. 1 is a block diagram illustrating the configuration of the information processing system 1. As illustrated in FIG. 1, the information processing system 1 includes a prediction section 11, an extraction section 12, and an output section 13. The prediction section 11 refers to people distribution information in a plurality of areas, to predict a future congested area and a future uncongested area among the plurality of areas. The extraction section 12 refers to user information on one or more users staying in the congested area and information related to the uncongested area, to extract a target user from the one or more users staying in the congested area, the target user being a target to be recommended to move to the uncongested area. The output section 13 outputs movement information for prompting the target user to move to the uncongested area.

### Program Implementation

The foregoing functions of the information processing system 1 may be realized by a program. The program in accordance with the present example embodiment causes the computer to function as: the prediction section 11 that refers to people distribution information in a plurality of areas, to predict a future congested area and a future uncongested area among the plurality of areas; the extraction section 12 that refers to user information on one or more users staying in the congested area and information related to the uncongested area, to extract a target user from the one or more users staying in the congested area, the target user being a target to be recommended to move to the uncongested area; and the output section 13 that outputs movement information for prompting the target user to move to the uncongested area.

### Flow of Information Processing Method S1

The following description will discuss the flow of an information processing method S1 in accordance with the present example embodiment with reference to FIG. 2. FIG. 2 is a flowchart illustrating the flow of the information processing method S1. Note that steps of the information processing method S1 may be carried out by a processor of the information processing system 1 or by a processor of another system. Alternatively, the steps may be carried out by processors provided in respective different apparatuses or systems.

As illustrated in FIG. 2, the information processing method S1 includes steps S11 to S13. In step S11, the processor refers to people distribution information in a plurality of areas, to predict a future congested area and a future uncongested area among the plurality of areas. In step S12, the processor refers to user information on one or more users staying in the congested area and information related to the uncongested area, to extract a target user from the one or more users staying in the congested area, the target user being a target to be recommended to move to the uncongested area. In step S13, the processor outputs movement information for prompting the target user to move to the uncongested area.

### Example Advantage of the Present Example Embodiment

As in the foregoing, the present example embodiment employs a configuration of: referring to people distribution information in a plurality of areas, to predict a future congested area and a future uncongested area among the plurality of areas; referring to user information on one or more users staying in the congested area and information related to the uncongested area, to extract a target user from the one or more users staying in the congested area, the target user being a target to be recommended to move to the uncongested area; and outputting movement information for prompting the target user to move to the uncongested area. Therefore, according to the present example embodiment, it is possible to achieve an example advantage of reducing congestion while improving satisfaction of a user who moves to escape the congestion.

### Second Example Embodiment

The following description will discuss a second example embodiment of the present invention in detail with reference to the drawings. The same reference numerals are given to constituent elements which have functions identical to those described in the first example embodiment, and descriptions as to such constituent elements are omitted as appropriate.

### Outline of Information Processing System 1A

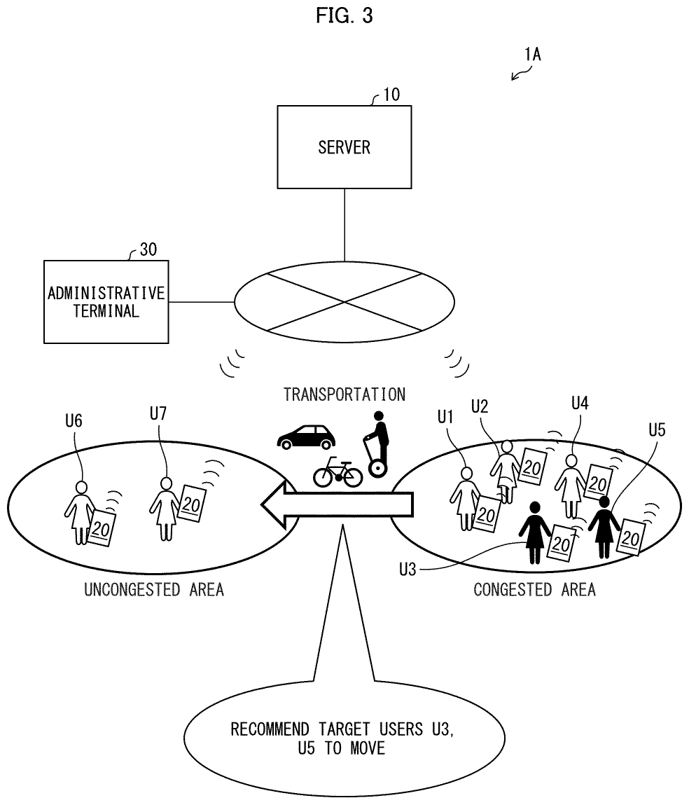

The following description will discuss an outline of an information processing system 1A in accordance with the second example embodiment with reference to FIG. 3. FIG. 3 is a schematic diagram for describing the outline of the information processing system 1A. As illustrated in FIG. 3, the information processing system 1A predicts a future congested area and a future uncongested area among a plurality of areas, and then outputs movement information for prompting users to move from the congested area to the uncongested area. From users (U1 to U5) staying in the congested area, the information processing system 1A extracts target users (U3, U5) who are targets to be recommended to move to the uncongested area. The information processing system 1A outputs movement information to user terminals 20 used by the target users (U3, U5). The information processing system 1A outputs the movement information to an administrative terminal that is managed by a provider of transportation available for moving from the congested area to the uncongested area.

Here, examples of the plurality of areas may include: facilities in a large shopping mall; towns handled by an estate developer; railway stations; tenants in a commercial building; stores in a shopping mall; theme park attractions; tourist sites in a metropolitan area; classrooms in an educational facility, and the like. However, the plurality of area are not limited to these examples.

### Configuration of Information Processing System 1A

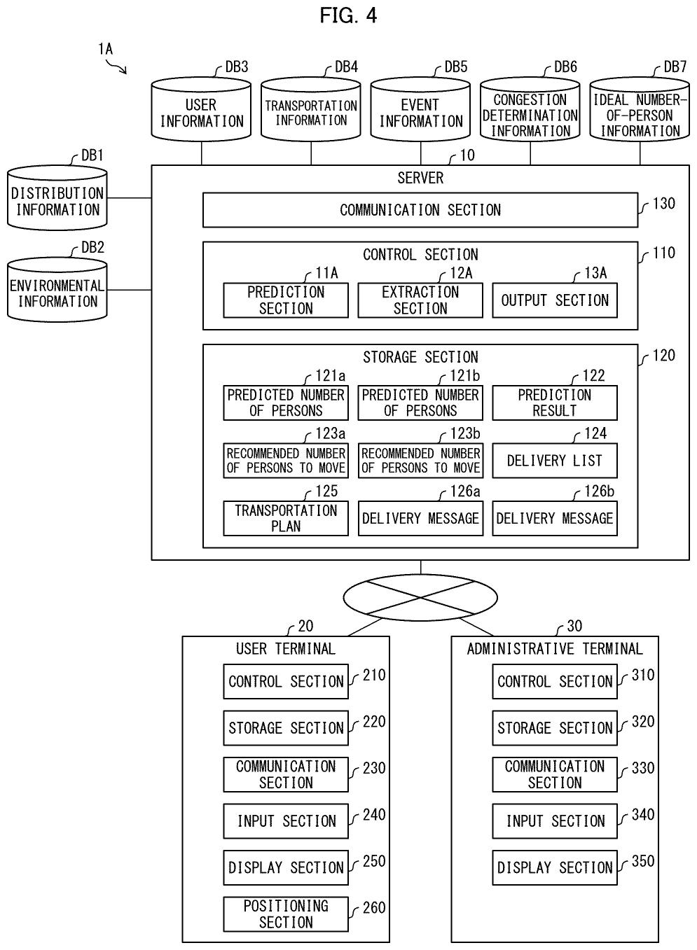

The following description will discuss the configuration of the information processing system 1A with reference to FIG. 4. FIG. 4 is a schematic diagram for describing the configuration of the information processing system 1A. As illustrated in FIG. 4, the information processing system 1A includes a server 10, a user terminal and an administrative terminal 30. The server 10 is communicably connected to both the user terminal 20 and the administrative terminal 30 via a network. The server 10 is connected to databases DB1 to DB7 so as to be capable of reading and writing information therefrom and thereto. Note that although FIG. 4 depicts one user terminal 20 and one administrative terminal 30, the information processing system 1A may include a plurality of user terminals 20 and may include a plurality of administrative terminals 30.

### Configuration of Server 10

The following description will discuss the configuration of the server 10 with reference to FIG. 4. As illustrated in FIG. 4, the server 10 includes a control section 110, a storage section 120, and a communication section 130. The control section 110 collectively controls the respective sections of the server 10. The control section 110 includes a prediction section 11A, an extraction section 12A, and an output section 13A. The storage section 120 stores various data for use by the control section 110. Further, the storage section 120 may store the predicted numbers of persons 121a and 121b, a prediction result 122, the recommended numbers of persons to move 123a and 123b, a delivery list 124, a transportation plan 125, and delivery messages 126a and 126b. The communication section 130 transmits and receives information to and from another apparatus via the network. The configurations of these sections and data will be described in Item “Flow of information processing method S1A”, which will be described later.

### Configuration of User Terminal 20

The user terminal 20 is a terminal that is used by a user. The user terminal 20 is a portable computer, and examples thereof may include a cellular phone, a smart phone, a tablet, a smart watch, a laptop personal computer, and the like. The following description will discuss the configuration of the user terminal 20 with reference to FIG. 4. As illustrated in FIG. 4, the user terminal 20 includes a control section 210, a storage section 220, a communication section 230, an input section 240, a display section 250, and a positioning section 260.

The control section 210 collectively controls the respective sections of the user terminal 20. The storage section 220 stores various data for use by the control section 210. The communication section 230 transmits and receives information to and from another apparatus via the network. The input section 240 accepts an operation of the user to the user terminal 20. The display section 250 displays an image. The positioning section 260 senses the location of the user terminal 20. Location information obtained by the positioning section 260 is reflected in real time in “current area” in the database DB3, which will be described later. For example, the positioning section 260 may sense the location on the basis of a received signal from a global positioning system (GPS), a beacon transmitting apparatus, a radio base station, or the like. However, the positioning technique used by the positioning section 260 is not limited thereto.

### Configuration of Administrative Terminal 30

The administrative terminal 30 is a terminal that is managed by a provider of transportation. Examples of the administrative terminal 30 may include a stationary computer and a portable computer. The following description will discuss the configuration of the administrative terminal with reference to FIG. 4. As illustrated in FIG. 4, the management terminal 30 includes a control section 310, a storage section 320, a communication section 330, an input section 340, and a display section 350. The control section 310 collectively controls the respective sections of the administrative terminal 30. The storage section 320 stores various data for use by the control section 310. The communication section 330 transmits and receives information to and from another apparatus via the network. The input section 340 accepts an operation of a user to the administrative terminal 30. The display section 350 displays an image.

### Database DB1: Distribution Information

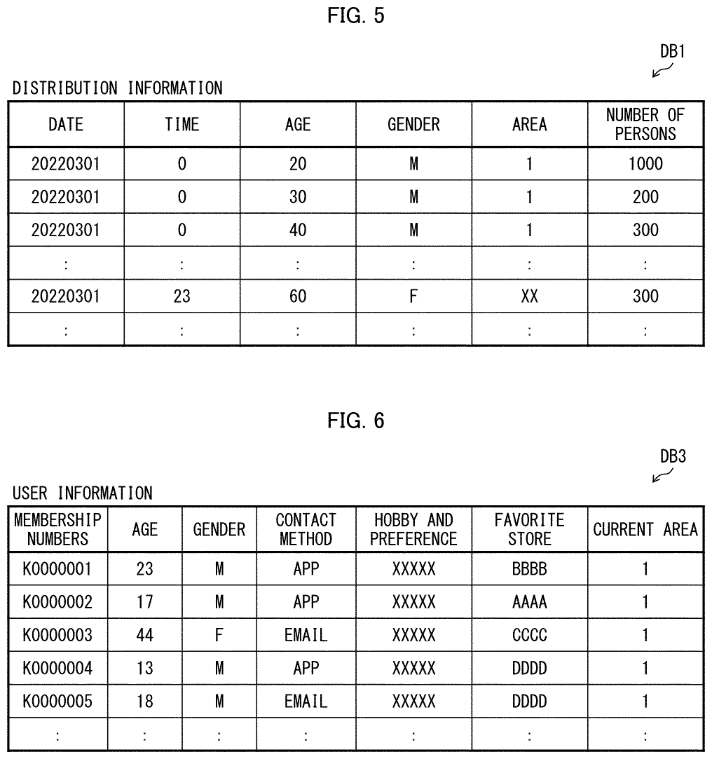

The database DB1 stores distribution information. The distribution information is information that indicates distributions of people in the plurality of areas. The following description will discuss an example of the distribution information with reference to FIG. 5. FIG. 5 is a diagram for describing the example of the distribution information. In the example illustrated in FIG. 5, the distribution information includes information that indicates a date, a time, an age, a gender, an area, and the number of persons. For example, the first line in FIG. 5 indicates that at 0:00 on Mar. 1, 2022, 1000 male “M” users in the age bracket of “20s” were present in an area with the identification information “1”. Here, it is assumed that identification information is given to each of the plurality of areas, and hereinafter, the area to which the identification information of “1” is assigned is also simply referred to as “area 1” or the like. Note that the distribution information only needs to be information that indicates people distributions in the plurality of areas, and the data structure thereof is not limited to the example illustrated in FIG. 5. Time intervals of the stored distribution information is 1 hour in FIG. 5; however, this is not limited thereto, and may be obtained, for example, every few hours, every days, or the like.

For example, such distribution information is collected by an apparatus (not illustrated) for collecting the distribution information and is stored in the database DB1. The database DB1 may be configured to be updated in real time as the collected distribution information is added.

### Database DB2: Environmental Information

The database DB2 stores environmental information. The environmental information indicates an external event surrounding the respective areas or the entirety of the plurality of areas. For example, the environmental information includes a date and time, identification information of an area, and information indicating the external event. Examples of the external event may include weather, a nearby event, and the like. Note that the nearby event is an event to be held on the periphery of the plurality of areas, that is, an event to be held in a region that is not included in any of the plurality of areas. The nearby event is different from an event, described later, which is held inside the areas. Note that the data structure of the environmental information is not limited to the example described in the foregoing.

For example, such environmental information is collected by an apparatus (not illustrated) for collecting the environmental information and is stored in the database DB2. The database DB2 may be configured to be updated in real time as the collected environmental information is added.

### Database DB3: User Information

The database DB3 stores user information. The user information may be, for example, information that indicates a user of a service provided in at least one of the plurality of areas. The following description will discuss an example of the user information with reference to FIG. 6. FIG. 6 is a diagram for describing the example of the user information. In the example illustrated in FIG. 6, the user information includes user identification information (membership number), information that indicates attributes of a user (age, gender, contact method, hobby and preference, favorite store), and information that indicates the current area of the user. Note that the data structure of the user information is not limited to the example illustrated in FIG. 6.

For example, the user identification information may be information registered through input of the user. The user identification information may be generated with reference to sensor information obtained by a sensor disposed in at least one of the plurality of areas. For example, the user identification information may be generated by an analyzer (not illustrated) configured to analyze an image captured by a camera disposed in any area and to identify an individual included in the image as a subject. The user identification information may be configured to be added in real time.

For example, the information that indicates the user attributes may be information registered through input of the user. For example, the information that indicates the user attributes may be generated by an analyzer (not illustrated) configured to refer to the abovementioned sensor information, the location information of the user terminal the usage situation of the application included in the user terminal 20, and the like, to analyze the user attributes. The information that indicates the user attributes may be configured to be updated in real time.

The information that indicates the current area of the user is generated by a determination apparatus (not illustrated) configured to refer to the location information of the user terminal 20 and information indicating the geographic regions of the respective areas, to determine the current area. Further, the information that indicates the current area is updated in real time in accordance with the positioning of the positioning section 260.

### Database DB4: Transportation Information

The database DB4 stores transportation information. The transportation information is information on transportation for moving among the plurality of areas. For example, the transportation information includes information that indicates identification information, a type, a route, a service schedule, and a possible offering amount of the transportation. For example, examples of the type may include, but are not limited to, a shuttle bus, an on-demand bus, a shared bicycle, a railway, a fix-route bus, and the like. An example of a route may be a route that connects area 1 and area 2. An example of the service schedule may be such that the departure from the area 1 is at 15:30 and the arrival at the area 2 is at 15:40. Examples of the possible offering amount may include the passenger capacity of a shuttle bus, a possible increase in number of vehicles, the number of shared bicycles, and the like. Note that the data structure of the transportation information is not limited to the example described in the foregoing.

For example, such transportation information may be stored in the database DB4 through input of an administrator who manages the plurality of areas or each of the areas. The transportation information may be collected by an apparatus (not illustrated) for collecting the information on transportation and be stored in the database DB4. The database DB4 may be configured to be updated in real time by using the collected transportation information.

### Database DB5: Event Information

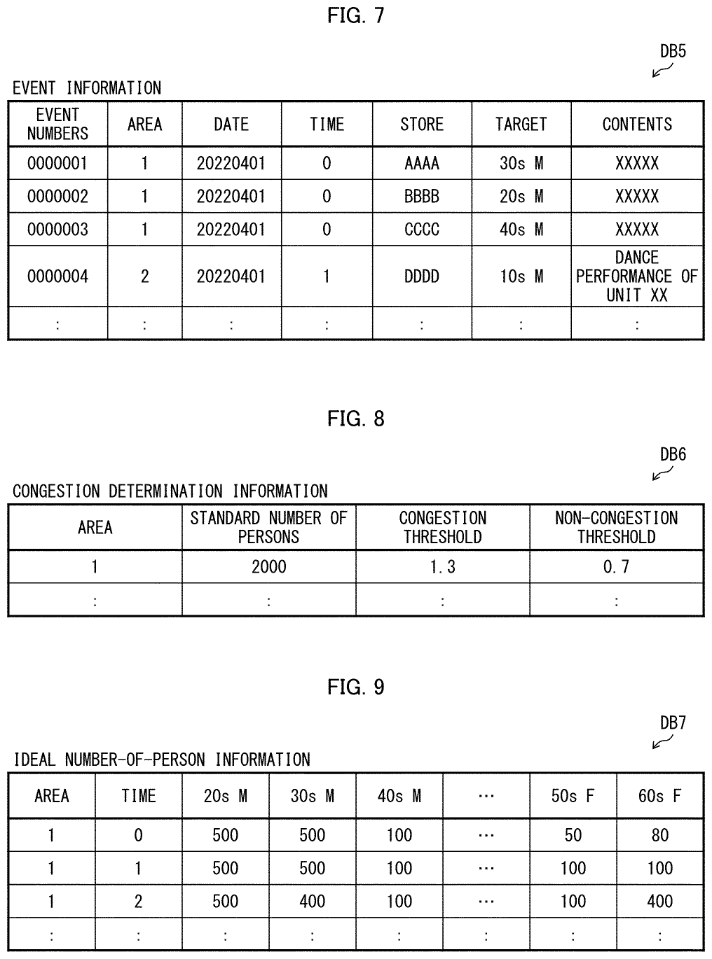

The database DB5 stores event information. The event information is information on an event to be carried out in any of the plurality of areas. The event is different from the abovementioned nearby event. The following description will discuss an example of the event information with reference to FIG. 7. FIG. 7 is a diagram for describing the example of the event information. In the example illustrated in FIG. 7, the event information includes information that indicates event identification information (event number), the identification information of an area in which the event is to be held, a date, a time, a store, and the a target. For example, the first line in FIG. 7 indicates that an event with the event number “0000001” is scheduled to be held in the area 1 at 0:00 on Apr. 1, 2022, targeting males in their 30s (30s M), sponsored by store AAAA. Note that the event information only needs to include the identification information of an area in which the event is to be held, and the data structure thereof is not limited to the example illustrated in FIG. 7.

For example, such event information may be stored in the database DB5 through input of, for example, an administrator who manages the area in which the event is to be held or a staff member or the like of the event. Further, such event information may be collected by an apparatus (not illustrated) for collecting information on an event to be held in any of the plurality of areas, and may be stored in the database DB5. The database DB5 may be configured to be updated in real time as the inputted or collected event information is added.

### Database DB6: Standard Number-of-Person Information

The database DB6 stores congestion determination information. The congestion determination information is information for use in determination as to whether each area is a congested area or an uncongested area. An example of the congestion determination information will be described with reference to FIG. 8. FIG. 8 is a diagram for describing the example of the congestion determination information. As illustrated in FIG. 8, the congestion determination information includes information that indicates area identification information, the standard number of persons, a congestion threshold, and a non-congestion threshold. The standard number of persons is the standard number of persons who stay simultaneously in the area concerned. The standard number of persons is for use in calculation of the level of congestion. The congestion threshold and the non-congestion threshold are thresholds for comparison with the congestion level. Note that the data structure of the congestion determination information is not limited to the example illustrated in FIG. 8. In the example of FIG. 8, the standard number of persons is set to be constant regardless of time; however, for example, a value that is variable in accordance with time may be set.

For example, such congestion determination information may be statistically calculated based on the number of persons who stayed in the past, the population density, and the like. The congestion determination information may be decided by an administrator of each area, an administrator of the information processing system 1A, or the like. The congestion determination information may be dynamically updated with reference to the distribution information.

Note that a required degree of congestion (or non-congestion) may differ among area administrators depending on, for example, whether it is desired to achieve a certain degree of congestion or it is desired to create a calm atmosphere. Therefore, the standard number of persons, the congestion threshold, or the non-congestion threshold may be set according to such an area administrator's request. This allows the area concerned to be determined as a congested area when the congestion level exceeds the required degree of congestion, and to be determined as an uncongested area when the congestion level falls below the required degree of non-congestion. Therefore, it is possible to achieve the required degree of congestion (or non-congestion) required by the administrator.

### Database DB7: Ideal Number-of-Person Information

The database DB7 stores ideal number-of-person information. The ideal number-of-person information is information on the ideal numbers of persons obtained by attribute in each area. The following description will discuss an example of the ideal number-of-person information with reference to FIG. 9. FIG. 9 is a diagram for describing the example of the ideal number-of-person information. As illustrated in FIG. 9, the ideal number-of-person information includes information that indicates the identification information of the area, a time, and the ideal number of persons by attribute. For example, the first line in FIG. 9 indicates that, in the area 1 at 0:00, the ideal number of males in their 20s is 500, the ideal number of males in their 30s is 500, the ideal number of males in their 40s is 100, . . . the ideal number of females in their 50s is 50, and the ideal number of females in their 60s is 80. For example, the total of the ideal numbers of persons by attribute in each area may be the standard number of persons in the area 1 stored in the database DB6. That is, the ideal numbers of persons by attribute in an area may be a breakdown of the standard number of persons in the area. Further, as illustrated in FIG. 9, values that are variable in accordance with time are set as such ideal numbers of persons by attribute.

For example, such ideal number-of-person information may be statistically calculated based on, for example, the numbers of persons who stayed in the past obtained by attribute. The ideal number-of-person information may be decided by an administrator of each area, an administrator of the information processing system 1A, or the like. The ideal number-of-person information may be dynamically updated with reference to the distribution information. Although, in this example, the ideal number-of-person information includes information that indicates a time, information that indicates a date or a day of a week may be included. Time intervals of the ideal number-of-person information stored is 1 hour in FIG. 9; however, this is not limited thereto.

### Flow of Information Processing Method S1A

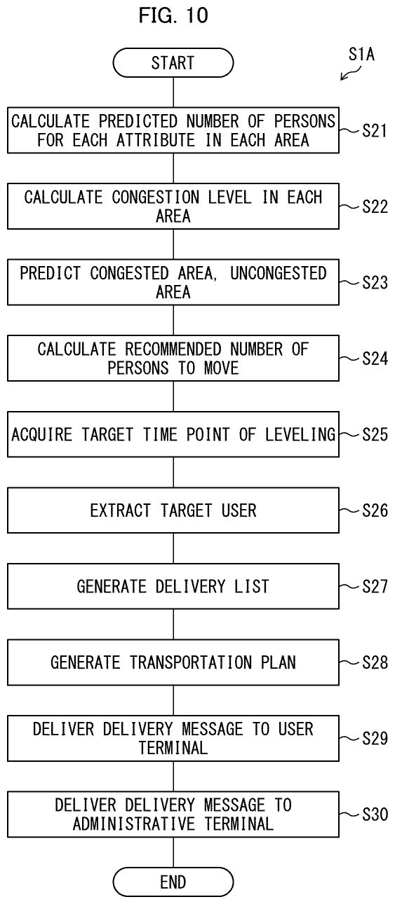

The information processing system 1A configured as described above carries out an information processing method S1A in accordance with the present example embodiment. The following description will discuss the flow of the information processing method S1A with reference to FIG. 10. FIG. 10 is a flowchart illustrating the flow of the information processing method S1A. As illustrated in FIG. 10, the information processing method S1A includes steps S21 to S28.

### Step S21

In step S21, the prediction section 11A refers to the distribution information and the environmental information stored in the databases DB1 and DB2, respectively, to predict the future predicted numbers of persons 121a and 121b in each area, and then the prediction section 11A stores the predicted numbers of persons 121a and 121b in the storage section 120. Here, the predicted number of persons 121a is the predicted number of staying persons obtained for each user attribute in each area. The predicted number of persons 121b is the predicted number of staying persons in each area. As used herein, the term “future” may be defined as a point in time after the current time point (e.g., 30 minutes later, 1 hour later, 1 day later, 1 week later, etc.). Alternatively, the term “future” may be a certain period from the current time point onward (e.g., from the current time point to 24 hours later) or the like.

For example, the prediction section 11A may identify past environmental information similar to future environmental information predicted, refer to past distribution information corresponding to the identified past environmental information, and predict the predicted numbers of persons 121a and 121b. For example, if it is requested to predict the predicted numbers of persons 121a and 121b of tomorrow, the prediction section 11A may refer to the environmental information and identify a past date of weather similar to the predicted tomorrow's weather (e.g., sunny). For example, the prediction section 11A may refer to the environmental information and identify the date on which a nearby event similar to a nearby event scheduled for tomorrow was held. The prediction section 11A may refer to the distribution information at the identified date and predict the predicted numbers of persons 121a and 121b.

The prediction section 11A may predict the predicted number of persons 121a by using a prediction model generated for each area based on the distribution information and the environmental information. For example, the prediction model receives a future time point or period as an input, and outputs the predicted numbers of persons 121a by attribute. Further, for example, the prediction section 11A may calculate the predicted number of person 121b for each area by summing the predicted numbers of person 121a by attribute outputted for each area. Specific examples of the technique for generating a prediction model may include, but are not limited to, logistic regression, decision tree, random forest, neural network, and the like.

For example, the prediction section 11A calculates the predicted numbers of persons 121a and 121b for each time point in a predetermined future period. For example, each time point in the predetermined future period may be, for example, every hour from the time point of the processing to 24 hours later, etc. In this case, if the point of time at which the information processing method S1A is executed (i.e., the current time) is 23:00 on Mar. 31, 2022, the predicted numbers of persons 121a and 121b are to be predicted at each time point of 0:00, 1:00, 2:00, . . . and 23:00 on Apr. 1, 2022. As described in the following specific examples, predicted values of the predicted numbers of persons 121a and 121b may differ among the time points in the predetermined future period.

### Specific Example of the Predicted Number of Persons 121a by Attribute

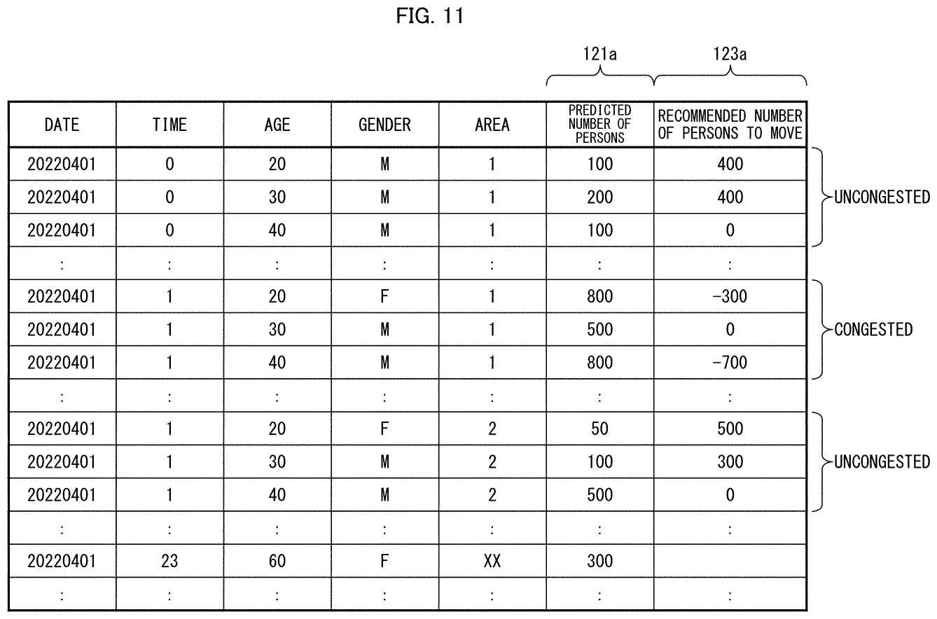

An example of the predicted number of persons 121a by attribute will be described with reference to FIG. 11. FIG. 11 is a diagram illustrating an example of information predicted on an attribute basis. As illustrated in FIG. 11, for each time point from 0:00 to 23:00 on Apr. 1, 2022, which are dates subsequent to the “current time” in this example, the predicted number of persons 121a is predicted for each area and for each attribute. For example, the first line of FIG. 11 indicates that the predicted number of persons 121a of males (M) in their 20s at 0:00 on Apr. 22, 2022 in the area 1 is 100.

### Specific Example of the Predicted Number of Persons 121b in Each Area

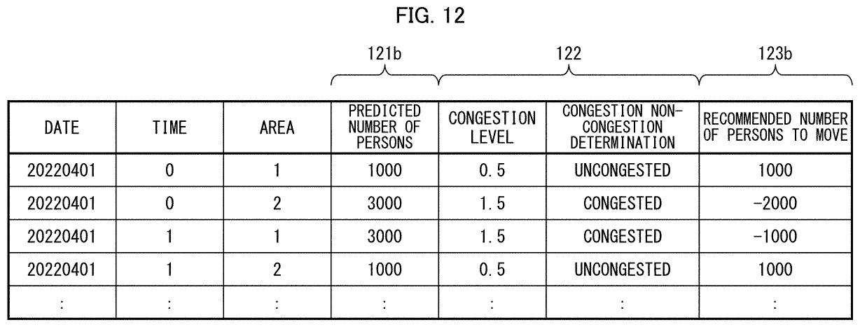

An example of the predicted number of persons 121b in each area will be described with reference to FIG. 12. FIG. 12 is a diagram illustrating an example of information predicted for each area. As illustrated in FIG. 12, the predicted number of persons 121b is predicted for each area at each time point, such as 0:00, 1:00, . . . on Apr. 1, 2022, which are dates subsequent to the “current time” in this example. For example, the first line of FIG. 12 indicates that the predicted number of persons 121b at 0:00 on Apr. 22, 2022 in the area 1 is 1000. The predicted number of persons 121b in the first line is obtained by summing the predicted numbers of person 121a by attribute of the date concerned in the area 1, out of the predicted numbers of person 121a by attribute shown in FIG. 11.

### Step S22

In step S22, the prediction section 11A refers to the predicted number of persons 121b and the database DB6 (congestion determination information), to calculate the congestion level in each area. For example, the prediction section 11A calculates the congestion level in each area at each time point in the predetermined future period. The specific example of “each time point in the predetermined future period” is as described above. A specific example of the calculation process of the congestion level will be described with reference to FIGS. 8 and 12.

### Specific Example of Congestion Level

For example, in a specific example of FIG. 12, the predicted number of persons 121b at 0:00 on Apr. 1, 2022 in the area 1 is 1000. Further, in a specific example of FIG. 8, the standard number of persons in the area 1 is 2000. Thus, to calculate the congestion level, the prediction section 11A divides the predicted number of persons 121b (1000) by the standard number of persons (2000), to obtain the congestion level of 0.5.

### Step S23

In step S23, the prediction section 11A refers to the calculated congestion level and the database DB6 (congestion determination information), to determine, for each area, whether the areas correspond to a congested area, an uncongested area, or a standard area. Further, the prediction section 11A stores, in the storage section 120, a prediction result 122 including the predicted congestion level and the determination result. This allows the prediction section 11A to predict a future congested area and a future uncongested area.

For example, the prediction section 11A determines, for each time point in the predetermined future period, for each area, whether the area corresponds to the congested area, the uncongested area, or the standard area. The specific example of “each time point in the predetermined future period” is as described above. The prediction results 122 may differ among the time points in the predetermined future period. A specific example of a process of predicting the congested area and the uncongested area will be described with reference to FIGS. 8 and 12.

### Specific Example of Uncongested Area

For example, in the specific example of FIG. 12, the congestion level at 0:00 on Apr. 1, 2022 in the area 1 is 0.5. Further, in the specific example of FIG. 8, the non-congestion threshold of the area 1 is 0.7. In this case, since the congestion level the non-congestion threshold, the prediction section 11A predicts that the area 1 is the uncongested area at the time concerned of the date concerned.

### Specific Example of Congested Area

Further, for example, in the specific example of FIG. 12, the congestion level at 1:00 on Apr. 1, 2022 in the area 1 is 1.5. Further, in the specific example of FIG. 8, the congestion threshold of the area 1 is 1.3. In this case, since the congestion threshold the congestion level, the prediction section 11A predicts that the area 1 is the congested area at the time concerned of the date concerned.

### Specific Example of Standard Area

Although not illustrated in the example of FIG. 12, when the congestion level is greater than the non-congestion threshold and is less than the congestion threshold, the prediction section 11A predicts that the area is the standard area, which is an area that is neither the congested area nor the uncongested area.

### Step S24

In step S24, as for the congested area and the uncongested area, the prediction section 11A refers to the databases DB6 and DB7, calculates the recommended numbers of persons to move 123a and 123b, and stores the calculated recommended numbers 123a and 123b in the storage section 120. Here, the recommended number of persons to move 123a is the number of persons who are recommended to move, which is calculated on an attribute basis of users in each of the congested area and the uncongested area. The recommended number of persons to move 123a is obtained by calculating the difference between the predicted number of persons 121a and the ideal number of persons. Further, the recommended number of persons to move 123b is the number of persons who are recommended to move, calculated for each of the congested area and the uncongested area. The recommended number of persons to move 123b is obtained by calculating the difference between the predicted number of persons 121b and the standard number of persons. As used herein, “recommended to move” refers to recommending movement from the area concerned to another area, or to recommending movement from another area to the area concerned.

For example, the prediction section 11A calculates the recommended numbers of persons to move 123a and 123b for each area at each time point in the predetermined future period. The specific example of “each time point in the predetermined future period” is as described above. The recommended numbers of persons to move 123a and 123b may differ among the time points in the predetermined future period.

### Specific Example of the Recommended Numbers of Persons to Move 123a by Attribute

An example of the recommended numbers of persons to move 123a by attribute will be described with reference to FIG. 11. For example, the first line in FIG. 11 indicates that the recommended number of persons to move 123a for males (M) in their 20s at 0:00 on Apr. 1, 2022 in the area 1 is 400. In this example, the recommended number of persons to move 123a is a positive value. This indicates that it is recommended to move one or more users with the attributes concerned to the area concerned from another area or other areas. That is, the first line in FIG. 11 indicates that it is recommended to move 400 males (M) in their 20s to the area 1 from another area or other areas. The recommended number of persons to move 123a is obtained by calculating the difference between the predicted number of persons 121a for males (M) in their 20s at the time and date concerned in the area 1 (i.e., 100) and the ideal number of persons for males (M) in their 20s at the date and time concerned in the area 1 (i.e., 500).

Further, for example, the fifth line in FIG. 11 indicates that the recommended number of persons to move 123a for males (M) in their 20s at 1:00 on Apr. 1, 2022 in the area 1 is −300. In this example, the recommended number of persons to move 123a is a negative value. This indicates that it is recommended to move one or more users with the attributes concerned from the area concerned to another area or other areas. That is, the fifth line in FIG. 11 indicates that it is recommended to move 300 males (M) in their 20s from the area 1 to another area or other areas. The recommended number of persons to move 123a is obtained by calculating the difference between the predicted number of persons 121a for males (M) in their 20s at the time and date concerned in the area 1 (i.e., 800) and the ideal number of persons for males (M) in their 20s at the date and time concerned in the area 1 (i.e., 500).

### Specific Example of the Recommended Number of Persons to Move 123b in Each Area

An example of the recommended number of persons to move 123b will be described with reference to FIG. 12. For example, the first line in FIG. 12 indicates that the recommended number of persons to move 123b at 0:00 on Apr. 1, 2022 in the area 1 is 1000. In this example, the recommended number of persons to move 123b is a positive value. This indicates that it is recommended to move one or more users to the area concerned from another area or other areas. That is, the first line in FIG. 12 indicates that it is recommended to move 1000 users to the area 1 from another area or other areas. The recommended number of persons to move 123b is obtained by calculating the difference between the predicted number of persons 121a at the time and date concerned in the area 1 (i.e., 1000) and the standard number of persons in the area 1 (i.e., 2000).

Further, for example, the second line in FIG. 12 indicates that the recommended number of persons to move 123b at 1:00 on Apr. 1, 2022 in the area 2 is −2000. In this example, the recommended number of persons to move 123b is a negative value. This indicates that it is recommended to move one or more users from the area concerned to another area or other areas. That is, the second line in FIG. 12 indicates that it is recommended to move 2000 users from the area 1 to another area or other areas. The recommended number of persons to move 123b is obtained by calculating the difference between the predicted number of persons 121a at the time and date concerned in the area 1 (i.e., 3000) and the standard number of persons in the area 1 (i.e., 1000).

### Repeat of Steps S21 to S24

Here, update of at least one of the databases DB1 to DB7, which are referred to in the information processing method S1A, may change at least one of the predicted numbers of persons 121a and 121b, the prediction result 122, and the recommended numbers of persons to move 123a and 123b. For example, the predicted numbers of persons 121a and 121b, the prediction result 122, and the recommended numbers of persons to move 123a and 123b at 3:00 on Apr. 1, 2022 in the area 1 can differ between when steps S21 to S24 are executed at 0:00 on Apr. 1, 2022 and when steps S21 to S24 are executed at 1:00 on the same day. Thus, the information processing system 1A may repeatedly carry out steps S21 to S24 at predetermined intervals. Accordingly, the predicted numbers of persons 121a and 121b, the prediction result 122, and the recommended numbers of persons to move 123a and 123b, which are stored in the storage section 120, are updated to the latest state.

### Step S25

In step S25, the control section 110 acquires information indicating a target time point of leveling. The target time point of leveling is a future time point when the people distributions in the plurality of areas are desired to be leveled out. For example, the target time point of leveling may be inputted on the basis of a request of, for example, a provider who provides a service in any of the plurality of areas, or an administrator and the like who manages the entirety of the plurality of areas. The target time point of leveling may be inputted, for example, in a relative expression form with respect to the input time point (e.g., “after 30 minutes”, “after 5 hours”, etc.), or may be inputted in an absolute expression form (e.g., “3:00 on Apr. 1, 2022”, etc.).

### Step S26

In step S26, among the users who are currently present in the congested area at the target time point of leveling, the extraction section 12A extracts a target user to be recommended to move to the uncongested area at the target time point of leveling. The extraction process is carried out, for example, with reference to one or both of the database DB3 (user information) and the database DB5 (event information). In the following description, the “congested area at the target time point of leveling” may be simply referred to as the “congested area”. Similarly, the “uncongested area at the time point of leveling” may be simply referred to as the “uncongested area”.

### Extraction Example 1 of Target User

For example, the extraction section 12A may refer to the user information on one or more users staying in the congested area, to extract, as a target user, a user who satisfies a condition regarding the information related to the uncongested area. Here, the “condition regarding the information related to the uncongested area” may be, for example, a condition regarding an event to be held in the uncongested area. Such a condition may be a user with an attribute that is targeted by the event to be held in the uncongested area. The targeted attribute may include, for example, age and gender. Further, such a condition may be a user who matches the event to be held in the uncongested area in the sense that the user's hobby and preference is relevant to the contents of the event. Furthermore, the condition may be a user who has registered a store that sponsors an event to be held in the uncongested area as a favorite store.

As a specific example, the following description will discuss a case in which the target time point of leveling is at 1:00 on Apr. 1, 2022. In this case, the extraction section 12A refers to the prediction result 122 of FIG. 12 and acquires information indicating the “area 1”, which is the congested area at the date and time concerned, and information indicating the “area 2”, which is the uncongested area at the date and time concerned. Further, the extraction section 12A refers to the database DB5 (event information) illustrated in FIG. 7 and acquires event information as to an event with the event number of “0000004” to be held in the uncongested area “area 2” at 1:00 on Apr. 1, 2022. The event information includes information that indicates the target of “male in his 10s (10s M)” and the contents of “dance performance of a unit XX”. The extraction section 12A refers to the database DB3 (user information) of FIG. 6 and identifies users “K0000001”, “K0000002”, “K0000003”, “K0000004”, “K0000005”, . . . , who are currently present in the congested area “area 1”. Among these, the extraction section 12A identifies “K0000001”, “K0000004”, and “K0000005”, which fall under the “male in his 10s”, which is targeted by the event with the event number of “0000004”. Then, among these, the extraction section 12A further identifies, for example, “K0000004” and “K0000005” as target users whose hobby and preference match the contents of the event with the event number of “0000004”, that is, “the dance performance of the unit XX”. Alternatively, among these, the extraction section 12A identifies, for example, “K0000004” and “K0000005” as target users who have registered the store “DDDD” that sponsors the event with the event number of “0000004”.

### Extraction Example 2 of Target User

Further, the extraction section 12A may refer to the ideal number-of-person information that indicates the ideal number of persons of one or more users with an attribute who are suited to stay in each of the congested area and the uncongested area, to extract a target user. As an example, the extraction section 12A may extract, as the target user, from the one or more users staying in the congested area, a user with an attribute that has the greater predicted number of persons 121a than the ideal number of persons in the congested area and with an attribute that has the fewer predicted number of persons 121a than the ideal number of persons in the uncongested area. In other words, the extraction section 12A may extract, as the target user, a user with an attribute that has a negative value of the recommended number of persons to move 123a in the congested area and a positive value of the recommended number of persons to move 123a in the uncongested area.

As a specific example, the following description will discuss a case in which the target time point of leveling is at 1:00 on Apr. 1, 2022. In this case, the extraction section 12A refers to the recommended number of persons to move 123a of FIG. 11, and identifies the attribute “female in her (20s F)” satisfying the following conditions. That is, (i) in the congested area “area 1”, the recommended number of persons to move 123a is a negative value “−300” at the target time point, and (ii) in the uncongested area “area 2”, the recommended number of persons to move 123a is a positive value “500” at the target time point. Then, the extraction section 12A refers to the database DB3 (user information), and identifies, as the target user, a user with the attribute “female in her 20s (20s F)” among users staying in the uncongested area “area 2”.

### Extraction Example 3 of Target User

The extraction section 12A may extract the target user by combining the abovementioned Extraction examples 1 and 2. For example, the extraction section 12A may extract a user with an attribute that satisfies the condition of Extraction example 2, and then, among these, extract a user with an attribute that satisfies the condition of Extraction example 1.

### Extraction Example 4 of Target User

The following description will discuss a case in which a plurality of congested areas are predicted at the target time point of leveling. In this case, the extraction section 12A extracts the target user from the plurality of congested areas. The following description will discuss a case in which a plurality of uncongested areas are predicted at the target time point of leveling. In this case, the extraction section 12A extracts the target user from the plurality of congested areas for each of the uncongested areas.

For example, for each congested area, the extraction section 12A solves an optimization problem of calculating the number of persons desirable to be moved from the congested area to any one of the uncongested areas. Specifically, for example, the extraction section 12A may refer to the prediction result 122 and the database DB6 (congestion determination information) for each area, and calculate the optimum number of persons to be moved so that the congestion level of each area approaches 1. For example, in the example of FIG. 12, only movement between the areas 1 and 2 is assumed for simplicity of description. In this case, at the target time point of leveling, that is, at 1:00 on Apr. 1, 2022, moving 1000 persons from the congested area “area 1” to the uncongested area “area 2” changes the congestion levels in both the areas 1 and 2 to 1. Here, any known technique may be employed as the technique for solving such an optimization problem, and the present invention is not limited to the example described above.

The extraction section 12A may extract, as the target user, from users who are currently present in the congested area “area 1”, a user of the number of persons to be moved (1000 users in this example), which is indicated by the solution of the optimization problem. As a technique for extracting the target user of the number of persons to be moved, the extraction section 12A may extract the target user at random, or alternatively, may extract the target user as follows: first, each user is scored from the viewpoints of Extraction examples 1 to 3 and the like, and next, the required number of users are extracted in the order of score from the highest score as the target users to be moved. Note that there may be a case in which the number of users who are currently present in the congested area is less than the number of persons to be moved indicated by the solution of the optimization problem. In this case, the extraction section 12A may extract the target user after the number of users staying in the congested area exceeds the number of persons to be moved.

### Step S27

In step S27, the output section 13A generates a delivery list 124 for delivering a delivery message 126a to the target user. The delivery list 124 is information related to the target user to whom the delivery message 126a is to be delivered.

### Specific Example of the Delivery List 124

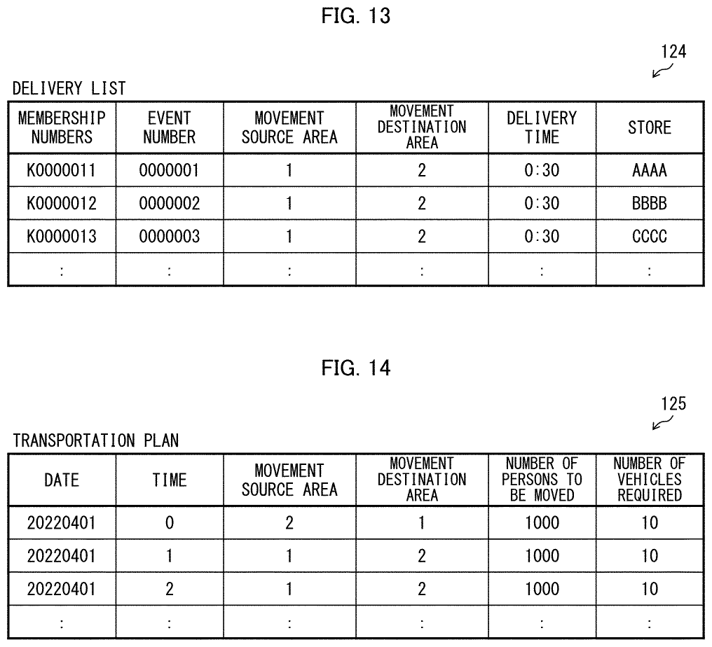

A specific example of the delivery list 124 will be described with reference to FIG. 13. FIG. 13 is a diagram for describing the specific example of the delivery list 124. As illustrated in FIG. 13, the delivery list 124 includes information that indicates the user identification information (membership number), the event identification information (event number), identification information of a movement source area, identification information of a movement destination area, a delivery time, and a store. The user identification information indicates the extracted target user. The event identification information indicates an event that has contributed to the extraction process of the target user. Note that the event is an event to be held in the movement destination area (uncongested area) at the target time point of leveling. The movement source area indicates an area in which the target user is currently present. Note that the movement source area is the congested area at the target time point of leveling. The movement destination area is the uncongested area at the target time point of leveling. The delivery time is a scheduled time at which the delivery message 126a is to be delivered to the target user. As the delivery time, any time point included in a time period from the current point to the target time point of leveling is separately determined. The favorite store is a favorite store of the target user and is a store that sponsors the abovementioned event.

### Step S28

In step S28, the output section 13A generates the transportation plan 125 to move the target user from the congested area to the uncongested area. The transportation plan 125 is information that indicates a plan based on demand of the target user for transportation.

### Specific Example of Transportation Plan 125

A specific example of the transportation plan 125 will be described with reference to FIG. 14. FIG. 14 is a diagram for describing the specific example of the transportation plan 125. As illustrated in FIG. 14, the transportation plan 125 includes information that indicates a date, a time, a movement source area, a movement destination area, the number of persons to be moved, and the number of vehicles required. The number of persons to be moved indicates the number of target users who are recommended to move from the movement source area (congested area) to the movement destination area (uncongested area). The number of vehicles required indicates a demand amount of transportation (e.g., a shuttle bus, in this example) required by the target user. This transportation plan 125 is referred to in order to generate the “information on transportation” to be included in the delivery messages 126a and 126b, which will be described later, from the congested area. If it is assumed that a plurality of types of transportation are available, the transportation plan 125 may further include information that indicates the type of transportation.

The output section 13A may generate the transportation plan 125 for one or more target time points of leveling. In the example of FIG. 14, the output section 13A generates the transportation plan 125 for each target time point of leveling, that is, “at 0:00 on Apr. 1, 2022”, “at 1:00 on the same day”, “at 2:00 on the same day”, . . . . For example, the first line in FIG. 14 indicates that, at 00:00 on Apr. 1, 2022, movement from the “area 2” to the “area 1” is recommended for 1000 target users, and 10 shuttle buses are required to achieve the movement of the 1000 target users.

### Step S29

In step S29, the output section 13A delivers the delivery message 126a to the user terminal 20 that is used by the target user. The delivery message 126a is an example of the “movement information for prompting the target user to move to the uncongested area”. For example, the delivery message 126a includes information related to the uncongested area. For example, the delivery message 126a also includes information on transportation available for moving from the congested area to the uncongested area. For example, the delivery message 126a is generated with reference to the delivery list 124 and the transportation plan 125, and is delivered to the user terminal 20 of the target user at the delivery time. Examples of the delivery method may include, but this is not limited to, email, push notification, and the like. On the display section 250 of the user terminal 20 of the target user, the delivery message 126a is displayed.

### Specific Example of Delivery Message 126a

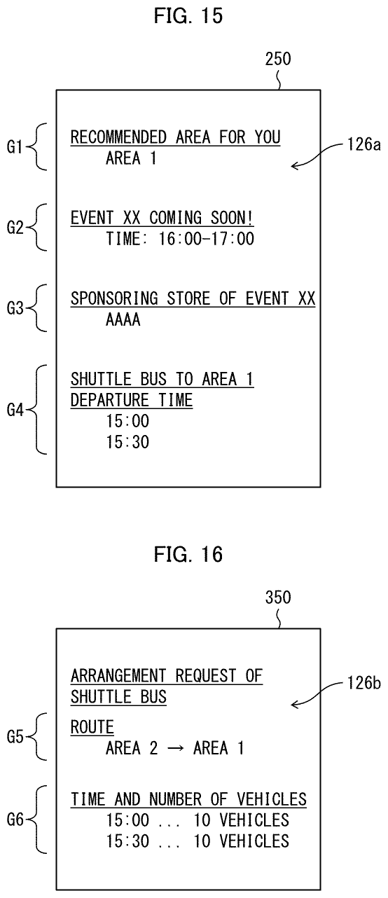

A specific example of the delivered message 126a will be described with reference to FIG. 15. FIG. 15 is a diagram for describing the specific example of the delivery message 126a displayed on the display section 250 of the user terminal 20. As illustrated in FIG. 15, the delivery message 126a includes information G1 to G4. The information G1 indicates information of “area 1”, which is an uncongested area as a “recommended area”. The information G2 indicates information on an event to be held in the uncongested area “area 1” (event name, the time at which the event is held, etc.). The information G3 indicates a store that sponsors the event and is a favorite store of the target user. The information G4 indicates information on transportation for moving to the uncongested area “area 1” (departure time of the shuttle bus). The information G2 and the information G3 are examples of the “information related to the uncongested area”. The information G4 is an example of the “information on transportation”. Visual recognition of such a delivery message 126a increases the motivation of the target user who is expected to move to the area 1. This increases the expectation that the target user will move from the congested area to the uncongested area. Further, when the target user actually moves to the uncongested area “area 1”, the congestion is reduced. In addition, when the target user actually moves to the uncongested area “area 1”, the satisfaction level of the target user is improved because the event suitable for the target user is to be held in the uncongested area.

### Step S30

In step S30, the output section 13A delivers the delivery message 126b to the administrative terminal 30 that is managed by the provider of the transportation. The delivery message 126b is an example of the “movement information for prompting the target user to move to the uncongested area”. For example, the delivery message 126b includes information on the demand for transportation available for moving from the congested area to the uncongested area. For example, the delivery message 126b may include a request for arrangement of transportation to the transportation provider. For example, the delivery message 126b is generated with reference to the transportation plan 125 and is delivered to the administrative terminal 30. Examples of the delivery method may include, but this is not limited to, email, push notification, and the like. On the display section 350 of the administrative terminal 30, the delivered message 126b is displayed.

### Specific Example of Delivery Message 126b

A specific example of the delivered message 126b will be described with reference to FIG. 16. FIG. 16 is a diagram for describing the specific example of the delivery message 126b displayed on the display section 350 of the administrative terminal 30. In the example illustrated in FIG. 16, the delivery message 126b indicates a request for arrangement of a shuttle bus to the provider of the shuttle bus. The delivery message 126b includes the information G5 and the information G6. The information G5 indicates a route in demand, that is, a route from the movement source area to the movement destination area included in the transportation plan 125. The information G6 indicates a time and the number of vehicles in demand, that is, a time and the number of vehicles required that are included in the transportation plan 125. Since such a delivery message 126b is delivered to the administrative terminal 30, it is possible to expect that the transportation corresponding to the demand of target users will be arranged. This increases the probability of the target user actually moving from the congested area to the uncongested area.

### Example Advantage of the Present Example Embodiment

As described in the foregoing, the present example embodiment employs, in addition to the same configuration as in the first example embodiment, a configuration in which the output section 13A delivers, to the user terminal 20 that is used by the target user, the delivery message 126a for prompting target users to move from the congested area to the uncongested area. Thus, according to the present example embodiment, in addition to the example advantage of the first example embodiment, it is possible to increase the motivation of the target user who has visually recognized the delivery message 126a to move to the uncongested area. This achieves an example advantage of increasing the expectation that the target user will move actually, resulting in reduced congestion.

Further, according to the present example embodiment, a target user who is a target to be recommended to move is extracted with reference to the user information (hobby and preference, etc., age, gender, favorite store, etc.). Thus, for an administrator of the uncongested area, there is an advantage in that it is possible to increase the expectancy of pulling in customers because the target user has been extracted on the basis of the detailed targeting method. Further, for area administrators, there is an advantage in that it is possible to increase the expectancy of pulling in customers even in the future in which non-congestion has been predicted every hours, every days, or the like. Further, there is an advantage in that, for area administrators, it is possible to more effectively pull in customers while reducing congestion of users. Further, according to the present example embodiment, there is an advantage for a user in that it is possible to improve the satisfaction while avoiding congestion, because a destination more suitable for the user is recommended.

Further, the present example embodiment employs a configuration in which the delivery message 126a includes the information related to the uncongested area. Thus, it is possible to achieve a further example advantage in that the target user who visually recognizes the delivery message 126a can notice information on the destination area of the movement to which the user is recommended to move, resulting in increased motivation to move to the uncongested area.

Further, the present example embodiment employs a configuration in which the delivery message 126a includes the information on transportation available for moving from the congested area to the uncongested area. This allows the target user who has visually recognized the delivery message 126a to notice specific transportation for moving to the movement destination area to which the target user is recommended to move. Thus, it is possible to avoid a situation in which the target user wants to move to the uncongested area but cannot move because the target user does not know what transportation is available. Therefore, it is possible to achieve a further example advantage of increasing the certainty that the target user who wants to move to the uncongested area moves.

Further, the present example embodiment employs a configuration in which the output section 13A delivers the delivery message 126b to the administrative terminal 30 that is managed by the provider of the transportation, and the delivery message 126b includes the information on the demand for transportation for moving from the congested area to the uncongested area. This allows the provider of the transportation that has noticed the delivery message 126b to prepare the transportation in accordance with the demand for the transportation. Thus, it is possible to avoid a situation in which the target user wants to move to the uncongested area but cannot move because of a shortage of transportation. Therefore, it is possible to achieve a further example advantage of increasing the certainty that the target user who wants to move to the uncongested area moves.

Further, the present example embodiment employs a configuration in which the extraction section 12A refers to the user information on one or more users staying in the congested area, to extract, as the target user, a user who satisfies a condition regarding the information related to the uncongested area. Here, it is possible to expect that a user who satisfies the condition regarding information related to the uncongested area will be highly motivated to move to the uncongested area. Therefore, it is possible to achieve a further example advantage in that the expectation that the target user will move to the uncongested area is increased.

Further, the present example embodiment employs a configuration in which the extraction section 12A refers to the ideal number-of-person information that indicates the ideal number of persons of one or more users with an attribute who are suited to stay in each of the congested area and the uncongested area, to extract, as the target user, from the one or more users staying in the congested area, a user with an attribute that has a greater predicted number of persons than the ideal number of persons in the congested area and with an attribute that has a fewer predicted number of persons than the ideal number of persons in the uncongested area. This achieves a further example advantage in that the actual number of persons can be brought closer to the ideal numbers of persons obtained by attribute set in each area.

### Variations

In the second example embodiment, the technique for extracting the target user is not limited to those described above. The data structure of each data stored in the storage section 120 is not limited to the examples described above. The output section 13A only needs to deliver the delivery message to at least one of the user terminal 20 and the administrative terminal 30, and does not necessarily need to deliver the message to both of them.

In the second example embodiment, the destination to which the delivery message 126a is outputted is not limited to the user terminal 20 used by the target user. For example, the output destination of the delivery message 126a may be a signage or the like disposed near the target user.

In the second example embodiment, the database DB5 may store advertisement information, incentive information, and the like, instead of or in addition to the event information. The advertisement information is information that indicates an advertisement for each area. The incentive information is information that indicates an incentive when a user moves to the area concerned. In this case, the extraction section 12A may refer to the advertisement information or the incentive information as information related to the uncongested area, to extract, as the target user, a user whose user information conforms to the advertisement information or the incentive information. The delivery message 126a may include the advertisement information or the incentive information for the uncongested area.

In the second example embodiment, the database DB4 may include discount information of a usage fee related to transportation in addition to information indicating transportation. For example, the delivery message 126a may include information related to discount information as to transportation available for moving to the uncongested area.

### Software Implementation Example

The functions of part of or all of the apparatuses constituting the information processing systems 1 and 1A can be realized by hardware such as an integrated circuit (IC chip) or can be alternatively realized by software.

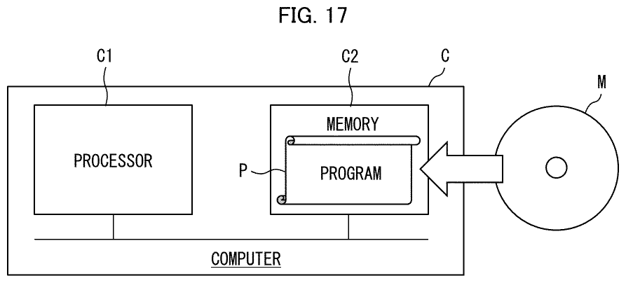

In the latter case, each of the apparatuses constituting the information processing systems 1 and 1A is realized by, for example, a computer that executes instructions of a program that is software realizing the foregoing functions. FIG. 17 illustrates an example of such a computer (hereinafter, referred to as “computer C”). The computer C includes at least one processor C1 and at least one memory C2. The memory C2 stores a program P for causing the computer C to function as the apparatuses constituting the information processing systems 1 and 1A. In the computer C, the processor C1 reads the program P from the memory C2 and executes the program P, so that the functions of the apparatuses constituting the information processing systems 1 and 1A are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with another apparatus. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can be described as, but not limited to, the following supplementary notes.

### Supplementary Note 1

An information processing system including:
prediction means for referring to people distribution information in a plurality of areas, to predict a future congested area and a future uncongested area among the plurality of areas;
extraction means for referring to user information on one or more users staying in the congested area and information related to the uncongested area, to extract a target user from the one or more users staying in the congested area, the target user being a target to be recommended to move to the uncongested area; and
output means for outputting movement information for prompting the target user to move to the uncongested area.

### Supplementary Note 2

The information processing system according to supplementary note 1, wherein the output means delivers the movement information to a user terminal that is used by the target user.

### Supplementary Note 3

The information processing system according to supplementary note 1 or 2, wherein the movement information includes the information related to the uncongested area.

### Supplementary Note 4

The information processing system according to any one of supplementary notes 1 to 3, wherein the movement information includes information on transportation available for moving from the congested area to the uncongested area.

### Supplementary Note 5

The information processing system according to any one of supplementary notes 1 to 4, wherein:
the movement information includes information on demand for transportation available for moving from the congested area to the uncongested area; and
the output means delivers the movement information to an administrative terminal that is managed by a provider of the transportation.

### Supplementary Note 6

The information processing system according to any one of supplementary notes 1 to 5, wherein the extraction means refers to the user information on one or more users staying in the congested area, to extract, as the target user, a user who satisfies a condition regarding the information related to the uncongested area.

### Supplementary Note 7

The information processing system according to any one of supplementary notes 1 to 6, wherein the extraction means refers to ideal number-of-person information that indicates an ideal number of persons of one or more users with an attribute who are suited to stay in each of the congested area and the uncongested area, to extract, as the target user, from the one or more users staying in the congested area, a user with an attribute that has a greater predicted number of persons than an ideal number of persons in the congested area and with an attribute that has a fewer predicted number of persons than an ideal number of persons in the uncongested area.

### Supplementary Note 8

An information processing method carried out by at least one processor, the method including:
referring to people distribution information in a plurality of areas, to predict a future congested area and a future uncongested area among the plurality of areas;
referring to user information on one or more users staying in the congested area and information related to the uncongested area, to extract a target user from the one or more users staying in the congested area, the target user being a target to be recommended to move to the uncongested area; and
outputting movement information for prompting the target user to move to the uncongested area.

### Supplementary Note 9

A program for causing a computer to function as:
prediction means for referring to people distribution information in a plurality of areas, to predict a future congested area and a future uncongested area among the plurality of areas;
extraction means for referring to user information on one or more users staying in the congested area and information related to the uncongested area, to extract a target user from the one or more users staying in the congested area, the target user being a target to be recommended to move to the uncongested area; and
output means for outputting movement information for prompting the target user to move to the uncongested area.

### Supplementary Note 10

An information processing system including at least one processor, the processor carrying out: a prediction process of referring to people distribution information in a plurality of areas, to predict a future congested area and a future uncongested area among the plurality of areas; an extraction process of referring to user information on one or more users staying in the congested area and information related to the uncongested area, to extract a target user from the one or more users staying in the congested area, the target user being a target to be recommended to move to the uncongested area; and an output process of outputting movement information for prompting the target user to move to the uncongested area.

Note that the information processing system may further include a memory. The memory may store a program for causing the processor to carry out the prediction process, the extraction process, and the output process. The program may be stored in a computer-readable non-transitory tangible storage medium.

### REFERENCE SIGNS LIST

1, 1A Information processing system
10 Server
20 User terminal
11, 11A Prediction section
12, 12A Extraction section
13, 13A Output section
30 Administrative terminal
C1 Processor
C2 Memory

1. An information processing system comprising at least one processor, the at least one processor carrying out:
a prediction process of referring to people distribution information in a plurality of areas, to predict a future congested area and a future uncongested area among the plurality of areas;
an extraction process of referring to user information on one or more users staying in the congested area and information related to the uncongested area, to extract a target user from the one or more users staying in the congested area, the target user being a target to be recommended to move to the uncongested area; and
an output process of outputting movement information for prompting the target user to move to the uncongested area.

2. The information processing system according to claim 1, wherein, in the output process, the at least one processor delivers the movement information to a user terminal that is used by the target user.

3. The information processing system according to claim 1, wherein the movement information includes the information related to the uncongested area.

4. The information processing system according to claim 1, wherein the movement information includes information on transportation available for moving from the congested area to the uncongested area.

5. The information processing system according to claim 1, wherein:
the movement information includes information on demand for transportation available for moving from the congested area to the uncongested area; and
in the output process, the at least one processor delivers the movement information to an administrative terminal that is managed by a provider of the transportation.

6. The information processing system according to claim 1, wherein, in the extraction process, the at least one processor refers to the user information on one or more users staying in the congested area, to extract, as the target user, a user who satisfies a condition regarding the information related to the uncongested area.

7. The information processing system according to claim 1, wherein, in the extraction process, the at least one processor refers to ideal number-of-person information that indicates an ideal number of persons of one or more users with an attribute who are suited to stay in each of the congested area and the uncongested area, to extract, as the target user, from the one or more users staying in the congested area, a user with an attribute that has a greater predicted number of persons than an ideal number of persons in the congested area and with an attribute that has a fewer predicted number of persons than an ideal number of persons in the uncongested area.

8. An information processing method carried out by at least one processor, the method comprising:
referring to people distribution information in a plurality of areas, to predict a future congested area and a future uncongested area among the plurality of areas;
referring to user information on one or more users staying in the congested area and information related to the uncongested area, to extract a target user from the one or more users staying in the congested area, the target user being a target to be recommended to move to the uncongested area; and
outputting movement information for prompting the target user to move to the uncongested area.

9. A non-transitory storage medium storing a program for causing a computer to carry out:
a prediction process of referring to people distribution information in a plurality of areas, to predict a future congested area and a future uncongested area among the plurality of areas;
an extraction process of referring to user information on one or more users staying in the congested area and information related to the uncongested area, to extract a target user from the one or more users staying in the congested area, the target user being a target to be recommended to move to the uncongested area; and
an output process of outputting movement information for prompting the target user to move to the uncongested area.
